(19) United States
(12) Patent Application Publication
(10) Pub. No.: US 2026/0292473 A1
(43) Pub. Date: Sep. 24, 2026

(54) METHOD AND SYSTEM FOR EXPOSURE OF UE ENERGY INFORMATIONS TO WIRELESS COMMUNICATION NETWORKS

(71) Applicants: Centre of Excellence in Wireless Technology, Chennai (IN); Indian Institute of Technology Madras (IIT Madras), Chennai (IN)

(72) Inventors: Ankita Lachhwani, Chennai (IN); Anusuya Balasubramanian, Chennai (IN); Abhijeet Abhimanyu Masal, Chennai (IN); Aswathy Subramaniam, Chennai (IN); Jeniston Deviraj Klutto Milleth, Chennai (IN); Bhaskar Ramamurthi, Chennai (IN)

(21) Appl. No.: 19/533,067

(22) Filed: Feb. 6, 2026

(30) Foreign Application Priority Data
Feb. 6, 2025 (IN) 202541010117

(51) Int. Cl. H04W 8/20; H04W 52/02

(52) U.S. Cl. CPC H04W 8/20; H04W 52/0277

(57) ABSTRACT

The present disclosure relates to providing energy-related information of a user equipment (UE) in a wireless communication network. An energy controlling function, implemented as a logically independent entity or network function, enables subscription-based exposure of UE energy event information to requesting entities, including internal network entities, operations, administration and maintenance (OAM) entities, and external application entities. Energy event exposure is performed subject to verification of user consent obtained from a consent-handling entity and supports attributes indicating one-time, periodic, or event-triggered reporting. Energy exposure information is obtained from at least one of the UE and a radio access network (RAN) using signalling procedures over core-UE and core-RAN interfaces, or via user-plane data packet exchange through a data-path handling entity. The exposed energy information may include battery status, battery capacity, energy consumption reports, energy saving mode operation, and radio condition information, enabling efficient and consent-aware energy information exposure.

### FIELD OF INVENTION

The present disclosure pertains to a field of wireless communication networks. In particular, the present disclosure relates to a method and a system facilitating exposure of energy information of a User Equipment (UE) to wireless communication networks.

### BACKGROUND

The subject matter discussed in the background section should not be assumed to be prior art merely because of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

The telecommunication industry continues to be a major contributor to global energy consumption owing to an increasing demand for higher data rates, ultra-low latency, massive device connectivity and always-on network availability. The widespread deployment of next generation networks, along with advanced radio technologies and dense network architectures, has further accelerated energy usage across network elements, UE, and supporting infrastructure.

In order to address these challenges, energy efficiency monitoring and optimization have emerged as critical requirements for the operation and management of the next generation networks. Accordingly, mechanisms have been introduced to monitor, measure, and expose network energy-related characteristics, such as power consumption, energy efficiency metrics, and operational states, to Operations, Administration, and Maintenance (OAM) systems as well as authorized third-party applications. Such exposure enables network operators and other stakeholders to gain visibility into energy consumption patterns and to make informed decisions for optimizing network behaviour.

Additionally, by providing access to energy-related information, operators or users may also be allowed or may suggest/request to dynamically modify system characteristics, configurations, or operational parameters in order to conserve energy or/and increase energy efficiency whenever and wherever feasible, without compromising service quality. Subsequently, these capabilities have been further extended to support the exposure of energy consumption characteristics associated with UE, thereby allowing OAM systems and authorized third-party applications to monitor, analyse, and optimize UE-level energy usage in a coordinated manner with network-side energy optimization strategies.

However, despite the potential benefits, the specific energy-related parameters associated with the UE that should be exposed, for instance, metrics indicative of power consumption, battery state, energy efficiency, or operational conditions still remains undefined. Furthermore, the mechanisms, interfaces, and procedures by which such UE energy characteristics are to be exposed to network management systems, OAM entities, or authorized third-party applications are not defined. The lack of well-defined parameters, exposure models, and standardized procedures for UE energy exposure introduces uncertainty and inconsistency in implementation, thereby limiting the ability of operators and applications to effectively utilize UE energy information for optimization purposes. Consequently, this absence of a structured framework for exposing UE energy characteristics presents a significant challenge in achieving efficient energy utilization and coordinated energy optimization across the UE and the network.

Therefore, considering the above limitations, there seems to be a need for development of a system as well as a method to facilitate efficient exposure of energy related information associated with the UE. The developed system and the method should also enable structured, reliable, and consistent access to UE energy characteristics for efficient monitoring and optimization.

### OBJECTS OF THE INVENTION

Some of the objects of the present disclosure, which at least one embodiment herein satisfy, are listed herein below.

It is an object of the present disclosure to overcome the aforementioned and other drawbacks existing in the prior art systems and methods.

It is a significant object of the present disclosure to provide a method for exposing energy related information of a UE within a wireless communication network in a controlled and standardized manner.

It is another object of the present disclosure to enable subscription-based access to UE energy event exposure in order to allow authorized entities to request and receive UE energy information based on pre-defined attributes.

It is another object of the present disclosure to provide the method such that the method is capable to ensure user privacy, regulatory compliance and subscribers permission by determining the availability of user consent prior to processing or exposing UE energy event information.

It is even another object of the present disclosure to provide the method such that the method is capable of supporting flexible reporting of energy exposure depending on the type of subscription requests.

It is even another object of the present disclosure to provide the method such that the method is capable of obtaining UE energy exposure information from at least one of the UE and a radio access network (RAN).

It is even another object of the present disclosure to provide the method such that the method enables indirect UE energy exposure signalling through intermediary network entities and through handling data paths for UE energy information transfer.

These and other objects and advantages of the present subject matter, will be apparent to a person skilled in the art after consideration of the following detailed description, taken into consideration with accompanied drawings in which preferred embodiments of the present subject matter are illustrated.

### SUMMARY OF THE INVENTION

The summary is provided to introduce aspects related to a method and a system facilitating exposure of energy information of a UE to wireless communication networks. This summary is not intended to identify key features or essential features of the claimed subject matter nor is it intended for use in determining or limiting the scope of the claimed subject matter.

According to an embodiment of the present subject matter, there is provided a method to provide energy information of a UE in a wireless communication network.

In an aspect, the method comprises receiving, by a first entity, a UE energy event exposure subscription first request from a second entity wherein the UE energy event exposure subscription request containing plurality of first attributes; determining, by the first entity, availability of a user consent from a third entity; sending by the first entity, the UE energy event exposure subscription second request to radio access network (RAN) when user consent is present; sending by the first entity, the UE energy event exposure subscription third request to the UE when the user consent is present; receiving by the first entity, a UE energy event exposure first response from the RAN comprising plurality of RAN info attributes; and receiving by the first entity, a UE energy event exposure second response from the UE comprising plurality of UE Energy Info attributes; sending, by the first entity to the second entity one of the UE energy event exposure subscription report when the user consent is present; and error message when the user consent is absent.

In an aspect, the plurality of first attributes comprises atleast one of first and second parameter.

In an aspect, the first parameter is event type indicating one of periodic, one time, or event triggered.

In an aspect, the second entity is one of an internal network entity, an operation, administration and maintenance (OAM) entity and an external application entity.

In an aspect, the user consent is at least one of UE privacy policy and subscriber permission.

In an aspect, the third entity is a user data management entity.

In an aspect, sending, by the first entity to the second entity is based on an attribute in the plurality of first attributes.

In an aspect, when a second entity in the at least one second entity is an external application entity, receiving by the first entity is performed using the network exposure API.

In an aspect, receiving UE energy event exposure first response is using one of a first response and at least one of a first notification.

In an aspect, receiving UE energy event exposure second response is using one of a second response and at least one of a second notification.

In an aspect, sending UE energy event exposure subscription report is using one of a third response and at least one of a third notification.

In an embodiment, there is provided a method for obtaining a UE energy information exposure from at least one of a user equipment (UE) and a radio access network (RAN), the method comprising sending, by the first entity, a UE energy event exposure subscription fourth request to the radio access network (RAN) using a second UE energy efficiency protocol; sending, by the first entity, a UE energy event exposure subscription fourth request to the UE using a first UE energy efficiency protocol; receiving, by the first entity, the UE energy event exposure subscription fourth response from the RAN comprising plurality of RAN info attributes; and receiving, by the first entity, the UE energy event exposure subscription fifth response from the UE comprising plurality of UE Energy info attributes.

In an aspect, receiving UE energy event exposure fourth response is using one of a fourth response and at least one of a fourth notification.

In an aspect, receiving UE energy event exposure fifth response is using one of a fifth response and at least one of a fifth notification.

In an aspect, the first UE energy efficiency protocol defines a plurality of signalling procedures between the first entity and the RAN, required for exchanging information associated to the UE energy event exposure.

In an aspect, the second UE energy efficiency protocol defines a plurality of signalling procedures between the first entity and the UE, required for exchanging information associated to the UE energy event exposure.

In an aspect, the fourth UE energy event exposure request and the fourth UE energy event exposure response is sent through the fourth entity to the RAN using a Core-RAN interface protocol message.

In an aspect, the fifth UE energy event exposure request and the fifth UE energy event exposure response is sent through the fourth entity to the UE via a Core-UE interface protocol message.

In another embodiment, there is provided a method for obtaining a UE energy exposure information from at least one of a UE and a radio access network (RAN), the method comprising receiving, by a fourth entity, a UE energy event exposure subscription sixth request from a first entity using a exposure service API; sending, by the fourth entity, a UE energy event exposure seventh request to the RAN using a core-RAN interface protocol message; sending, by the fourth entity, a UE energy event exposure eighth request to the UE using an interface protocol message; receiving, by the fourth entity, the UE energy event exposure sixth response from the RAN comprising plurality of RAN info attributes; receiving, by the fourth entity, the UE energy event exposure seventh response from the UE comprising plurality of UE Energy info attributes; sending, by the fourth entity the UE energy event exposure eighth response to the first entity; and sending, by the first entity the UE energy event exposure ninth response to the first entity.

In an aspect, the eighth response and the ninth response is sent as a single consolidated response.

In an aspect, the fourth entity is an access and mobility management entity.

In an aspect, wherein receiving UE energy event exposure sixth response is using one of a sixth response and at least one of a sixth notification.

In an aspect, receiving UE energy event exposure seventh response is using one of a seventh response and at least one of a seventh notification.

In an aspect, receiving UE energy event exposure eighth response is using one of a eighth response and at least one of a eighth notification.

In an aspect, receiving UE energy event exposure ninth response is using one of a ninth response and at least one of a ninth notification.

In another embodiment, there is provided a method for obtaining UE energy exposure information from the UE, the method comprising receiving by a fifth entity, a UE energy event exposure subscription ninth request from a first entity using a data path exposure service API; sending by fifth entity, a UE energy event exposure tenth request to the UE using downlink data packet; receiving by the fifth entity, at least one of UE event energy exposure tenth response and UE energy exposure notification from the UE comprising plurality of UE Energy info attributes using uplink data packet; and sending, by the fifth entity, at least one of the UE energy event exposure eleventh response and the UE energy exposure notification to the first entity using the data path exposure service API.

In an aspect, the fifth entity handles a data path for energy information transfer for the requested UE.

In an aspect, the fifth entity is a user plane entity.

In an aspect, the downlink data packet includes an identifier of the UE energy event exposure request.

In an aspect, the first entity is an energy information function which can be logically independent entity or an independent Network Function (NF).

In an aspect, the plurality of UE Energy Info attributes comprises at least one of battery status information, battery capacity, UE energy saving mode operation, and energy consumption reports.

In an aspect, the plurality of RAN info attributes includes radio condition information for the UE.

To further understand the characteristics and technical contents of the present subject matter, a description relating thereto will be made with reference to the accompanying drawings. However, the drawings are illustrative only but not used to limit the scope of the present subject matter.

Various objects, features, aspects, and advantages of the inventive subject matter will become more apparent from the following detailed description of preferred embodiments, along with the accompanying drawing figures in which numerals represent like components.

### BRIEF DESCRIPTION OF THE DRAWINGS

It is to be noted that, however, that the appended drawings illustrate only typical embodiments of the present subject matter and are therefore not to be considered for limiting of its scope, for the invention may admit to other equally effective embodiments. A detailed description is given with reference to the accompanying figures. In the figures, a reference number identifies the figure in which the reference number first appears. The same numbers are used throughout the figures to refer like features and components. Some embodiments of the system or methods or structure in accordance with embodiments of the present subject matter are now described, by way of example, and with reference to accompanying figures, in which

FIG. 1 illustrates an exemplary architecture of a system for facilitating exposure of energy related information, in accordance with an exemplary embodiment of the present disclosure;

FIG. 2 illustrates an exemplary network architecture for energy exposure request and response handling, in accordance with an embodiment of the present disclosure;

FIG. 3 illustrates an exemplary network architecture for energy exposure request and response handling, in accordance with another embodiment of the present disclosure;

FIG. 4 illustrates an exemplary network architecture for energy exposure request and response handling, in accordance with yet another embodiment of the present disclosure;

FIG. 5 (a-b) illustrates an example method of working of the system, in accordance with an embodiment of the present disclosure;

FIG. 6 (a-b) illustrates an example method of working of the system to facilitate energy exposure response from a UE and a RAN, in accordance with an embodiment of the present disclosure;

FIG. 7 (a-b) illustrates an example method of working of the system to facilitate energy exposure response from the UE and the RAN, in accordance with another embodiment of the present disclosure; and

FIG. 8 (a-b) illustrates an example method of working of the system to facilitate energy exposure response from the UE, in accordance with yet another embodiment of the present disclosure.

The figures depict embodiments of the present subject matter for the purposes of illustration only. A person skilled in the art will easily recognize from the following description that alternative embodiments of the structures and methods illustrated herein may be employed without departing from the principles of the disclosure described therein.

### DESCRIPTION OF THE INVENTION

The description set forth below in connection with the appended drawings is intended as a description of various embodiments of the present invention and is not intended to represent the only embodiments in which the present invention may be practiced. Each embodiment described in this invention is provided merely as an example or illustration of the present invention, and should not necessarily be construed as preferred or advantageous over other embodiments. The description includes specific details for the purpose of providing a thorough understanding of the present invention. However, it will be apparent to those skilled in the art that the present invention may be practiced without these specific details.

The terms “comprise”, “comprising”, or any other variations thereof used in the disclosure, are intended to cover a non-exclusive inclusion, such that a device, system, assembly that comprises a list of components does not include only those components but may include other components not expressly listed or inherent to such system, or assembly, or device. In other words, one or more elements in a system or device proceeded by “comprises . . . a” does not, without more constraints, preclude the existence of other elements or additional elements in the system or device.

The present disclosure relates to providing energy-related information of a UE in a wireless communication network. The present disclosure employs an energy information function, implemented as a logically independent entity or network function, to enable subscription-based exposure of UE energy event information to requesting entities, including internal network entities, operations, administration and maintenance (OAM) entities, and external application entities. Herein, energy event exposure is performed subject to verification of user consent and supports configurable attributes indicating one-time, periodic, or event-triggered reporting. Energy exposure information is obtained from at least one of the UE and a radio access network (RAN) using defined signalling procedures over core-UE and core-RAN interfaces, or using user-plane data packet exchange through a data-path handling entity. The exposed information may include UE battery status, battery capacity, energy consumption reports, energy saving mode operation, and radio condition information, thereby enabling efficient, scalable, and consent-aware energy information exposure within the wireless communication network.

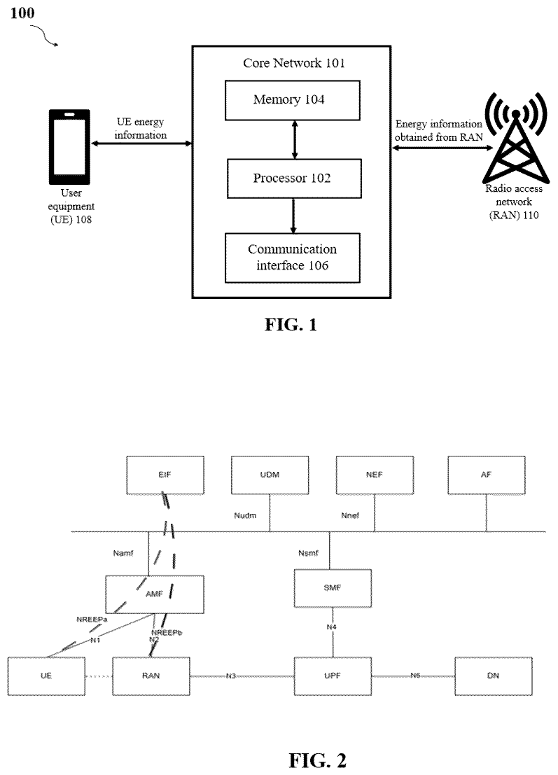

FIG. 1 illustrates an exemplary architecture of a system (100) for facilitating exposure of energy related information, in accordance with an exemplary embodiment of the present disclosure.

In an aspect, it may be observed that the system architecture comprises of a UE (108), a RAN (110) and a core network (101). The core network (101) is having one or more processors (102) operatively coupled to a memory (104) and a communication interface (106). The one or more processors (102) may comprise of a plurality of entities namely, a first entity, a second entity, a third entity, a fourth entity and a fifth entity, to execute functioning of the system (100). Among other capabilities, the one or more processors (102) are configured to execute instructions stored in the memory to perform one or more operations which enable exposure of energy related information. In an aspect, the second entity may be located outside the core network (101) as well.

In an aspect, the communication (106) interface enables the system (100) to exchange signalling with external entities, which includes a UE (108) and a radio access network (RAN) (110), via one or more wired or wireless communication links.

In an aspect, the UE (108) is configured to generate and report energy-related information associated with the operation of the UE, such as battery state, power consumption metrics, or other energy indicators.

In an aspect, the RAN (110) is configured to derive or estimate RAN-based UE energy information, for example based on radio conditions, scheduling behaviour, transmission parameters, or network observations related to the UE (108).

In an aspect, both the UE energy information and the RAN-derived UE energy information are communicated to a network entity comprising the one or more processors (102) and the memory (104), thereby enabling centralized collection and processing of UE energy information within a core network.

In an aspect, the communication interface (106) is configured to receive UE energy information reports from the UE (108) and RAN-derived UE energy information from the RAN (110). The one or more processors (102) are configured to process, correlate, and aggregate the received energy information. The memory (104) is configured to store UE energy profiles, historical energy information, or related configuration data.

In some embodiments, the core network entity may further send energy information configuration or reporting parameters to one or more of the UE (108) and the RAN (110), for example to control reporting conditions, reporting periodicity, or the type of energy information to be shared. Such signalling may be performed over control-plane interfaces.

In an aspect, additionally, the system (100) may also comprise of one or more interfaces. The interface may include a variety of interfaces, for example, interfaces for data input and output devices, referred to as I/O devices, storage devices and the like. The interface may facilitate communication within different components of the system (100) and also may provide communication pathways to one or more components of the system (100). Examples of such components include but is not limited to the one or more processors, data storage, etc. The interface may support wired or wireless protocols, such as Ethernet, Wi-Fi, Bluetooth, 5G, or other radio access technologies.

FIG. 2 illustrates an exemplary network architecture for energy exposure request and response handling, in accordance with an embodiment of the present disclosure.

In an aspect, as can be observed from the figure, the network architecture comprises the first entity configured to operate as an energy information entity, the second entity configured to request energy exposure information, the UE (108) and the RAN (110), along with one or more core network entities enabling control plane and user plane communication.

In an aspect, the second entity initiates an energy exposure request by sending an UE energy exposure subscription request message towards the first entity. The energy exposure request may correspond to a one-time request, a periodic request, or an event-triggered request associated with the UE. Upon receiving the UE energy exposure request, the first entity evaluates the request and coordinates energy exposure signalling towards at least one of the UE and the RAN.

In an embodiment, the first entity may communicate with the UE (108) using a fourth entity i.e., an access and mobility management entity, where the energy exposure request is conveyed using a second UE energy event exposure protocol. The UE (108), upon receiving the energy exposure request, generates an energy exposure response comprising UE-related energy information and transmits the response back towards the first entity.

In an aspect, the first entity may also further communicate with the RAN (110) using the access and mobility management entity, where the energy exposure request is conveyed using a first UE energy event exposure protocol. The RAN (110), in response to the energy exposure request, provides an energy exposure response including radio condition information or network-related parameters associated with the UE (108).

Therefore, as depicted in FIG. 2, in this manner, the first entity aggregates the energy exposure response received from at least one of the UE (108) and the RAN (110) and transmits a corresponding energy exposure response, or an error indication when applicable, to the second entity.

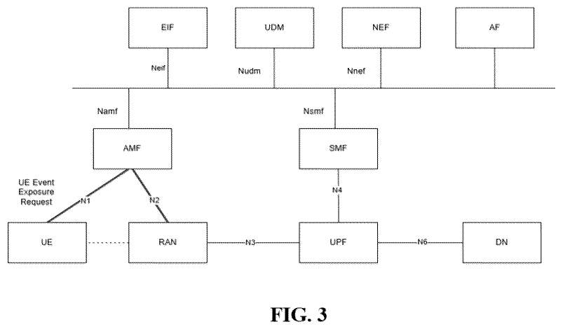

FIG. 3 illustrates an exemplary network architecture for energy exposure request and response handling, in accordance with another embodiment of the present disclosure.

In an aspect, as shown in FIG. 3, the network architecture comprises the UE (108) in communication with the RAN (110), and a plurality of core network entities interconnected via service-based interfaces. The UE (108) is communicatively coupled to the RAN (110) over an access link, and the RAN (110) is further connected to one or more core network entities to support control plane and user plane communication.

In an aspect, the first entity is configured to receive an energy exposure request from the second entity about energy-related information associated with the UE. Upon receiving the request, the first entity initiates signalling towards the UE (108) and/or the RAN (110) to obtain the requested energy exposure information.

In an aspect, the first entity communicates with the fourth entity configured to manage access and mobility for the UE (108). The fourth entity forwards an energy exposure request towards the UE (108) using a UE-core interface protocol message over a first interface. In parallel or alternatively, the fourth entity communicates with the RAN (110) using a core-RAN interface protocol message over a second interface to convey the energy exposure request towards the RAN (110).

In an aspect, upon receipt of the energy exposure request, the UE (108) and/or the RAN (110) generate an energy exposure response comprising energy-related information associated with the UE (108). The energy exposure response is returned to the fourth entity using corresponding UE-core and Core-RAN protocol messages such as NREEPa and NREEPb. The fourth entity forwards the received response to the first entity for further processing to the energy requesting entity.

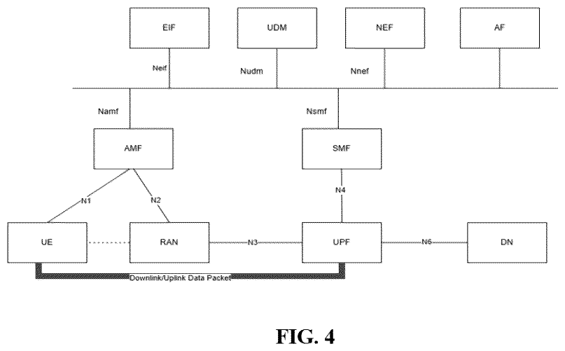

FIG. 4 illustrates an exemplary network architecture for energy exposure request and response handling, in accordance with yet another embodiment of the present disclosure.

In an aspect, there is provided the fifth entity within the communication system, where the fifth entity is configured to handle a data path for energy-related information associated with the UE (108). The fifth entity may operate as a user-plane handling entity in the core network and is capable of exchanging user-plane data packets with the UE (108) over an established data path.

In an aspect, the fifth entity is configured to receive, from the first entity, the request corresponding to UE Energy Event Exposure Subscription. The request indicates that energy exposure information associated with the UE is to be obtained and reported. Upon receipt of the request, the fifth entity facilitates the transfer of energy-related information by utilizing the data path associated with the UE.

In an aspect, for the purpose of obtaining the energy exposure information, the fifth entity sends a downlink data packet towards the UE over the data path. The downlink data packet carries a UE energy exposure request, and in some implementations may further include an identifier associated with the UE energy-exposure request, enabling correlation between the request and a subsequent response.

In an aspect, the UE (108) is configured to generate energy exposure information in response to the received request by using an uplink data packet transmitted over the same data path. The uplink data packet includes a UE energy exposure response including UE energy info corresponding to the energy exposure request. Upon receipt of the uplink data packet, the fifth entity forwards the UE energy exposure response to the first entity.

In this manner, the fifth entity enables efficient acquisition and reporting of UE energy exposure information through user-plane data packet exchange, thereby reducing signalling overhead, supporting timely delivery of energy exposure information, and allowing scalable handling of energy event exposure subscriptions for multiple UEs.

In an aspect, herein, all the energy exposure requests and responses may be classified into different categories for example, first request, first response, second request, second response, etc., for the sake of clarity. These are clearly explained in subsequent sections.

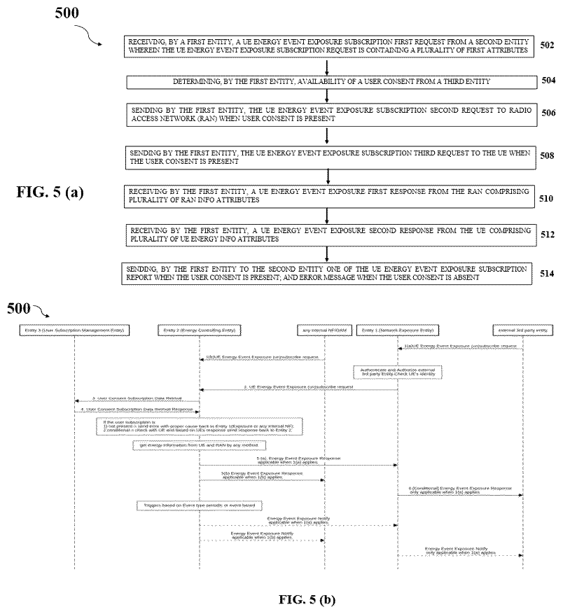

FIG. 5 (a) illustrates an example method (500) of working of the system (100), in accordance with an exemplary embodiment of the present disclosure. The corresponding flow is also illustrated in FIG. 5 (b). The order in which the method (500) is described is not intended to be construed as a limitation, and any number of described method blocks may be combined in order to implement the method (500) or an alternative method. Furthermore, the method (500) may be implemented by the one or more processors (102), processing resource or computing device(s) through any suitable hardware, non-transitory machine readable medium/instructions, or combination thereof.

At block (502), the method (500) comprises receiving, by a first entity, a UE energy event exposure subscription first request from a second entity wherein the UE energy event exposure subscription request is containing a plurality of first attributes. The UE energy event exposure subscription request may be received via a communication interface (106) and may indicate an intent of the second entity to subscribe to one or more UE energy event exposure notifications. In an aspect, the subscription request may comprise the plurality of first attributes associated with the requested UE energy event exposure, such as an identifier of the UE, one or more energy event types to be monitored, reporting conditions, reporting periodicity, validity duration of the subscription, or threshold criteria related to UE energy consumption or energy exposure. The plurality of first attributes enables the first entity to interpret the scope and triggering conditions of the requested UE energy event exposure.

At block (504), the method (500) comprises determining, by the first entity, availability of a user consent from a third entity. In an aspect, the determining comprises verifying whether a valid user consent corresponding to the UE energy event exposure subscription request is available, prior to further processing of the request. The determination may further include checking one or more conditions such as validity duration of the consent, scope of permitted data usage, applicability to the identified UE, or compliance with predefined policy or regulatory requirements. In response to determining that the user consent is unavailable the method may prevent further processing of the subscription request.

At block (506), the method (500) comprises sending by the first entity, the UE energy event exposure subscription second request to radio access network (RAN) when user consent is present. The subscription request sent to the RAN (110) and/or the UE (108) may include the at least one attribute associated with the UE energy event exposure. The at least one attribute indicates one of reporting criteria, reporting conditions, thresholds, or subscription validity parameters. The subscription request enables the RAN (110) and/or the UE (108) to initiate collection or monitoring of UE energy-related information in accordance with the requested subscription.

At block (508), the method (500) comprises sending by the first entity, the UE energy event exposure subscription third request to the UE when the user consent is present.

At block (510), the method (500) comprises receiving by the first entity, a UE energy event exposure first response from the RAN comprising plurality of RAN info attributes.

At block (512), the method (500) comprises receiving by the first entity, a UE energy event exposure second response from the UE comprising plurality of UE Energy Info attributes.

At block (514), the method (500) comprises sending, by the first entity to the second entity one of the UE energy event exposure subscription report when the user consent is present; and error message when the user consent is absent.

In an aspect, the energy event exposure response is sent when the availability of the user consent has been determined to be present. The energy event exposure response may comprise information received from at least one of the UE and the RAN and may further include energy event data in accordance with the UE energy event exposure subscription request and associated attributes.

In another aspect, when the user consent is determined to be absent, the first entity may send an error message to the second entity, wherein the error message indicates denial of the UE energy event exposure subscription request due to lack of user authorization.

In an aspect, the energy event exposure subscription request comprises atleast one of a first and a second parameter and the energy event exposure subscription response comprises the second parameter. The first parameter may be indicative of one or more conditions, triggers, thresholds, reporting criteria, or control instructions associated with monitoring or exposing a UE energy event. Moreover, the energy event exposure subscription response is sent based on the first parameter, such that the occurrence, timing, frequency, or content of the energy event exposure subscription response is determined in accordance with the first parameter specified in the energy event exposure subscription request. In some embodiments, the first parameter may be used to control when or under what conditions the second parameter is reported.

In an aspect, availability of the user consent from the third entity is determined based on a user consent subscription data (UE privacy and subscriber permission). Further, the first entity may be an energy information function which is a logically independent entity or an independent Network Function (NF), and the second entity may be one of internal network entity or an operation, administration and maintenance (OAM) entity or an external application entity.

In an aspect, the third entity is user data management entity.

In an aspect, further, sending, by the first entity to the second entity is based on an attribute in the plurality of first attributes, where the first entity sends one of a response and at least one of a second notification.

In an aspect, the second entity in the at least one second entity may be an external application entity, receiving by the first entity is performed using the network exposure entity.

In an aspect, the method comprises receiving UE energy event exposure first response is using one of a first response and at least one of a first notification.

In an aspect, the method comprises receiving UE energy event exposure second response is using one of a second response and at least one of a second notification In an aspect, the method comprises sending UE energy event exposure subscription report is using one of a third response and at least one of a third notification.

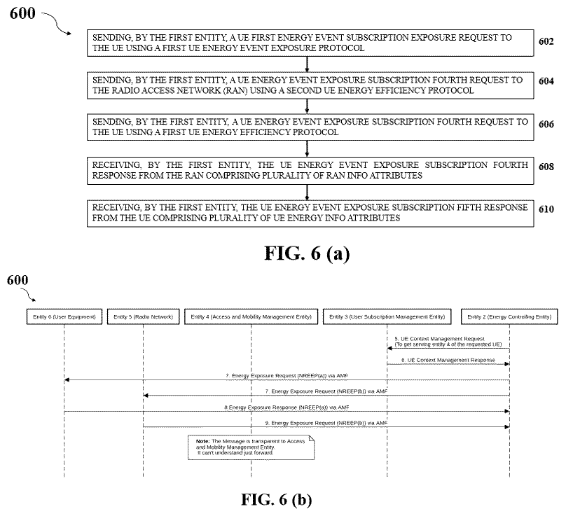

FIG. 6 (a) illustrates an example method (600) of working of the system (100) to facilitate energy exposure response from the UE (108) and the RAN (110), in accordance with an embodiment of the present disclosure. The corresponding flow is also illustrated in FIG. 6 (b). The order in which the method (600) is described is not intended to be construed as a limitation, and any number of described method blocks may be combined in order to implement the method (600) or an alternative method. Furthermore, the method (600) may be implemented by the one or more processors (102), processing resource or computing device(s) through any suitable hardware, non-transitory machine readable medium/instructions, or combination thereof.

At block (602), the method (600) comprises sending, by the first entity, a UE first energy event subscription exposure request to the UE using a first UE energy event exposure protocol. The first UE energy event exposure protocol defines signalling procedures, message formats, and communication mechanisms for delivering the UE first energy event exposure subscription request to the UE (108). In some embodiments, the sending is performed via one or more communication interfaces and in accordance with the first UE energy event exposure protocol, such that the UE (108) is configured to process the subscription request and generate a corresponding energy event exposure response or an error indication based on the requested attributes, applicable policies, or operational constraints.

At block (604), the method (600) comprises sending, by the first entity, a UE energy event exposure subscription fourth request to the radio access network (RAN) using a second UE energy efficiency protocol. The second UE energy event exposure protocol defines signalling procedures, message formats, and communication mechanisms for sending the second energy exposure request to the RAN (110). In some embodiments, the second energy exposure request is communicated over a core-to-RAN interface in accordance with the first UE energy event exposure protocol, thereby enabling the RAN (110) to process the request and generate a corresponding energy exposure response or an error indication based on radio conditions, network policies, or operational constraints.

At block (606), the method (600) comprises sending, by the first entity, a UE energy event exposure subscription fourth request to the UE using a second UE energy efficiency protocol.

At block (608), the method (600) comprises receiving, by the first entity, the UE energy event exposure subscription fourth response from the RAN comprising plurality of RAN info attributes.

At block (610), the method (600) comprises receiving, by the first entity, the UE energy event exposure subscription fifth response from the UE comprising plurality of UE Energy info attributes.

In an aspect, the method (600) comprises receiving UE energy event exposure fourth response using one of a fourth response and at least one of a fourth notification.

In an aspect, the method (600) comprises receiving UE energy event exposure fifth response using one of a fifth response and at least one of a fifth notification.

In an aspect, the first UE energy event exposure message is sent through the fourth entity to the UE using a Core-UE interface protocol message.

In an aspect, the first UE energy event exposure message is sent through the fourth entity to the RAN using a Core-RAN interface protocol message.

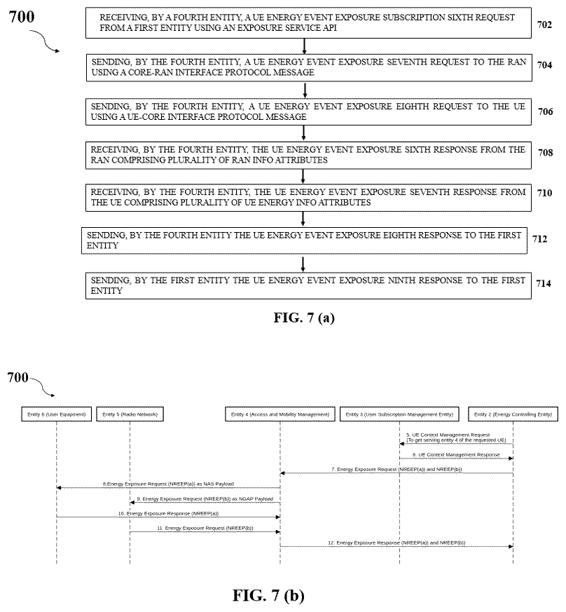

FIG. 7 (a) illustrates an example method (700) of working of the system (100) to facilitate energy exposure response from the UE (108) and the RAN (110), in accordance with another embodiment of the present disclosure. The corresponding flow is also illustrated in FIG. 7 (b). The order in which the method (700) is described is not intended to be construed as a limitation, and any number of described method blocks may be combined in order to implement the method (700) or an alternative method. Furthermore, the method (700) may be implemented by the one or more processors (102), processing resource or computing device(s) through any suitable hardware, non-transitory machine readable medium/instructions, or combination thereof.

At block (702), the method (700) comprises receiving, by a fourth entity, a UE energy event exposure subscription sixth request from a first entity using an exposure service API.

At block (704), the method (700) comprises sending, by the fourth entity, a UE energy event exposure seventh request to the RAN using a core-RAN interface protocol message. The fourth entity is configured to forward the Core-RAN interface protocol message in accordance with predefined signalling procedures, thereby enabling the RAN (110) to receive and process the UE energy exposure request. In some embodiments, the RAN (110) generates a corresponding energy exposure response or an error indication based on radio conditions, network policies, or supported reporting capabilities.

At block (706), the method (700) comprises sending, by the fourth entity, a UE energy event exposure eighth request to the UE using an UE-core interface protocol message. The fourth entity operates as an intermediary for conveying the UE energy exposure request between the first entity and the UE (108) and is configured to forward the UE-core interface protocol message in accordance with predefined signalling procedures. In some embodiments, the UE-core interface protocol message encapsulates the UE energy exposure request such that the UE (108) is enabled to receive, interpret, and process the request and to generate a corresponding energy exposure response or an error indication based on the requested parameters, supported capabilities, or operational conditions.

At block (708), the method (700) comprises receiving, by the fourth entity, the UE energy event exposure sixth response from the RAN comprising plurality of RAN info attributes.

At block (710), the method (700) comprises receiving, by the fourth entity, the UE energy event exposure seventh response from the UE comprising plurality of UE Energy info attributes.

At block (712), the method (700) comprises sending, by the fourth entity the UE energy event exposure eighth response to the first entity.

At block (714), the method (700) comprises sending, by the first entity the UE energy event exposure ninth response to the first entity.

In an aspect, the eighth response and the ninth response is sent as a single consolidated response.

In an aspect, the fourth entity is an access and mobility management entity.

In an aspect, the fourth UE energy event exposure request and the fourth UE energy event exposure response is sent through the fourth entity to the RAN using a Core-RAN interface protocol message.

In an aspect, the fifth UE energy event exposure request and the fifth UE energy event exposure response is sent through the fourth entity to the UE via a Core-UE interface protocol message.

In an aspect, the method (700) comprises receiving UE energy event exposure sixth response using one of a sixth response and at least one of a sixth notification.

In an aspect, the method (700) comprises receiving UE energy event exposure seventh response using one of a seventh response and at least one of a seventh notification.

In an aspect, the method (700) comprises receiving UE energy event exposure eighth response using one of an eighth response and at least one of a eighth notification.

In an aspect, the method (700) comprises receiving UE energy event exposure ninth response using one of a ninth response and at least one of a ninth notification.

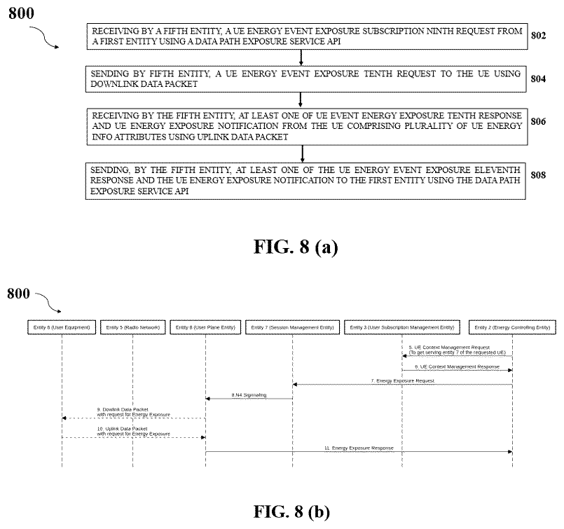

FIG. 8 (a) illustrates an example method (800) of working of the system (100) to facilitate energy exposure response from the UE (108), in accordance with yet another embodiment of the present disclosure. The corresponding flow is also illustrated in FIG. 8 (b). The order in which the method (800) is described is not intended to be construed as a limitation, and any number of described method blocks may be combined in order to implement the method (800) or an alternative method. Furthermore, the method (800) may be implemented by the one or more processors (102), processing resource or computing device(s) through any suitable hardware, non-transitory machine readable medium/instructions, or combination thereof.

At block (802), the method (800) comprises receiving by a fifth entity, a UE energy event exposure subscription ninth request from a first entity using a data path exposure service API. The fifth entity, upon receiving the request, establishes or utilizes an existing data path for conveying energy-related information between the UE (108) and the first entity. In some embodiments, the fifth entity may also facilitate delivery of subsequent signalling or data packets associated with the UE energy event exposure, thereby enabling efficient transfer of energy exposure requests and corresponding responses.

At block (804), the method (800) comprises sending by fifth entity, a UE energy event exposure tenth request to the UE using downlink data packet. The downlink data packet may include an identifier of the UE energy-exposure request.

In an aspect, the downlink data packet encapsulates the UE energy exposure request along with one or more parameters, attributes, or identifiers associated with the requested energy information. The fifth entity transmits the downlink data packet over the established data path in accordance with applicable communication procedures, thereby enabling the UE (108) to receive and process the UE energy exposure request.

At block (806), the method (800) comprises receiving by the fifth entity, at least one of UE event energy exposure tenth response and UE energy exposure notification from the UE comprising plurality of UE Energy info attributes using uplink data packet. The fifth entity receives the uplink data packet over the established data path and extracts the UE energy exposure response in accordance with pre-defined communication procedures.

At block (808), the method (800) comprises sending, by the fifth entity, at least one of the UE energy event exposure eleventh response and the UE energy exposure notification to the first entity using the data path exposure service API.

In an aspect, the fifth entity forwards the energy exposure response extracted from the uplink data packet to the first entity over an established communication interface. In some embodiments, the fifth entity sends the energy exposure response in accordance with pre-defined signalling or data transfer procedures, thereby enabling the first entity to process the energy exposure response or to perform subsequent actions based on the received energy information.

In an aspect, the fifth entity handles a data path for energy information transfer for the requested UE and the fifth entity is a user plane entity.

In an aspect, the first entity is an energy information function which can be logically independent entity or an independent Network Function (NF).

In an aspect, the plurality of UE Energy Info attributes comprises at least one of battery status information, battery capacity, UE energy saving mode operation, and energy consumption reports.

In an aspect, the plurality of RAN info attributes includes radio condition information for the UE.

In an aspect, the methods (500, 600, 700, 800) may also be executed based on instructions in a non-transitory computer readable medium, as will be readily understood. The non-transitory computer readable medium may include for example, digital memories, magnetic storage media, such as one or magnetic disks and magnetic tapes, hard drives or optically readable digital data storage media. The methods (500, 600, 700, 800) are described with reference to the functions performed by the one or more processors (102). Additionally, the implementation of these methods is not limited to such examples.

### Technical Advantages

All in all, the invention disclosed in the present disclosure is having the following advantages:
The invention disclosed in the present disclosure enables controlled and consent-aware exposure of UE energy-related information, thereby preventing unauthorized access while allowing energy data to be shared only when user consent is available.
The present disclosure provides a flexible mechanism that operates across multiple network layers by supporting energy exposure responses from both the UE and the RAN using distinct protocols.
The use of subscription attributes such as one-time, periodic, or event-triggered reporting enables efficient signalling by avoiding unnecessary or redundant energy exposure requests and responses.
The separation of request handling, data path management, and response forwarding across multiple logical entities enables scalable deployment across a large number of UEs without overloading network functions.

In an example, the one or more processors (102) as disclosed herein, may be a single processing unit or a number of units, all of which could include multiple computing units. The processor (102) may be implemented as one or more microprocessors, microcomputers, microcontrollers, digital signal processors, central processing units, logical processors, virtual processors, state machines, logic circuitries, and/or any devices that manipulate signals based on operational instructions.

The processor (102) may include one or more general purpose processors (e.g., INTEL® or Advanced Micro Devices® (AMD) microprocessors) and/or one or more special purpose processors (e.g., digital signal processors or Xilinx® System on Chip (SOC) Field Programmable Gate Array (FPGA) processor), MIPS/ARM-class processor, a microprocessor, a digital signal processor, an application specific integrated circuit, a microcontroller, a state machine, or any type of programmable logic array.

In an example, the processor (102) may comprise of different entities, modules, engines, units, wherein the module(s), engine(s), and/or unit(s) may include a program, a subroutine, a portion of a program, a software component or a hardware component capable of performing a stated task or function. As used herein, the module(s), engine(s), and/or unit(s) may be implemented on a hardware component such as a server independently of other modules, or a module can exist with other modules on the same server, or within the same program. The module(s), engine(s), and/or unit(s) may be implemented on a hardware component such as processor one or more microprocessors, microcomputers, microcontrollers, digital signal processors, central processing units, state machines, logic circuitries, and/or any devices that manipulate signals based on operational instructions. The module(s), engine(s), and/or unit(s) when executed by processing unit (208) may be configured to perform any of the described functionalities.

It should be noted that the description and figures merely illustrate the principles of the present subject matter. It should be appreciated by those skilled in the art that conception and specific embodiment disclosed may be readily utilized as a basis for modifying or designing other structures for carrying out the same purposes of the present subject matter. It should also be appreciated by those skilled in the art that by devising various systems that, although not explicitly described or shown herein, embody the principles of the present subject matter and are included within its spirit and scope. Furthermore, all examples recited herein are principally intended expressly to be for pedagogical purposes to aid the reader in understanding the principles of the present subject matter and the concepts contributed by the inventor(s) to furthering the art and are to be construed as being without limitation to such specifically recited examples and conditions. The novel features which are believed to be characteristic of the present subject matter, both as to its organization and method of operation, together with further objects and advantages will be better understood from the above-mentioned description when considered in connection with the accompanying figures.

Although embodiments for the present subject matter have been described in language specific to package features, it is to be understood that the present subject matter is not necessarily limited to the specific features described. Rather, the specific features and methods are disclosed as embodiments for the present subject matter. Numerous modifications and adaptations of the system/device of the present invention will be apparent to those skilled in the art, and thus it is intended by the appended claims to cover all such modifications and adaptations which fall within the scope of the present subject matter.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances, where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

It will be further appreciated that functions or structures of a plurality of components or steps may be combined into a single component or step, or the functions or structures of one-step or component may be split among plural steps or components. The present invention contemplates all these combinations. Unless stated otherwise, dimensions and geometries of the various structures depicted herein are not intended to be restrictive of the invention, and other dimensions or geometries are possible. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention. The present invention also encompasses intermediate and end products resulting from the practice of the methods herein. The use of “comprising” or “including” also contemplates embodiments that “consist essentially of” or “consist of” the recited feature.

1. A method to provide energy information of a user equipment (UE) in a wireless communication network, the method comprising:
receiving, by a first entity, a UE energy event exposure subscription first request from a second entity wherein the UE energy event exposure subscription request containing plurality of first attributes;
determining, by the first entity, availability of a user consent from a third entity;
sending by the first entity, the UE energy event exposure subscription second request to radio access network (RAN) when user consent is present;
sending by the first entity, the UE energy event exposure subscription third request to the UE when the user consent is present;
receiving by the first entity, a UE energy event exposure first response from the RAN comprising plurality of RAN info attributes; and
receiving by the first entity, a UE energy event exposure second response from the UE comprising plurality of UE Energy Info attributes;
sending, by the first entity to the second entity one of,
the UE energy event exposure subscription report when the user consent is present; and
error message when the user consent is absent.

2. The method as claimed in claim 1, wherein the plurality of first attributes comprises at least one of first and second parameter, and wherein the first parameter is event type indicating one of one time, periodic or event triggered.

3. (canceled)

4. (canceled)

5. The method as claimed in claim 1, wherein the user consent is at least one of UE privacy policy and subscriber permission.

6. (canceled)

7. The method as claimed in claim 1, wherein sending, by the first entity to the second entity is based on an attribute in the plurality of first attributes.

8. (canceled)

9. The method as claimed in claim 1, wherein receiving UE energy event exposure first response is using one of a first response and at least one of a first notification, and wherein receiving UE energy event exposure second response is using one of a second response and at least one of a second notification; wherein sending UE energy event exposure subscription report is using one of a third response and at least one of a third notification.

10. The method as claimed in claim 1, wherein the third entity is user data management entity; further, the first entity is an energy information function which can be logically independent entity or an independent Network Function (NF); wherein the second entity is one of an internal network entity, an operation, administration and maintenance (OAM) entity and an external application entity; wherein, when a second entity is an external application entity, receiving by the first entity is performed using the network exposure entity.

11. The method as claimed in claim 1, wherein the plurality of UE Energy Info attributes comprises at least one of battery status information, battery capacity, UE energy saving mode operation, and energy consumption reports; wherein the plurality of RAN info attributes includes radio condition information for the UE.

12. A method for obtaining a UE energy exposure information from at least one of a user equipment (UE) and a radio access network (RAN), the method comprising:
sending, by the first entity, a UE energy event exposure subscription fourth request to the radio access network (RAN) using a first UE energy efficiency protocol;
sending, by the first entity, a UE energy event exposure subscription fifth request to the UE using a second UE energy efficiency protocol;
receiving, by the first entity, the UE energy event exposure subscription fourth response from the RAN comprising plurality of RAN info attributes; and
receiving, by the first entity, the UE energy event exposure subscription fifth response from the UE comprising plurality of UE Energy info attributes.

13. The method as claimed in claim 12, wherein receiving UE energy event exposure fourth response is using one of a fourth response and at least one of a fourth notification, wherein receiving UE energy event exposure fifth response is using one of a fifth response and at least one of a fifth notification.

14. (canceled)

15. The method as claimed in claim 12, wherein the first UE energy efficiency protocol defines a plurality of signalling procedures between the first entity and the RAN, required for exchanging information associated to the UE energy event exposure, and wherein the second UE energy efficiency protocol defines a plurality of signalling procedures between the first entity and the UE, required for exchanging information associated to the UE energy event exposure.

16. The method as claimed in claim 12, wherein the plurality of UE Energy Info attributes comprises at least one of battery status information, battery capacity, UE energy saving mode operation, and energy consumption reports, and wherein the plurality of RAN info attributes includes radio condition information for the UE.

17. The method as claimed in claim 12, wherein the UE energy event exposure subscription fourth request is sent through access and mobility managing entity to the RAN using a Core-RAN interface protocol message, and wherein the UE energy event exposure subscription fifth request is sent through the access and mobility managing entity to the UE via a Core-UE interface protocol message.

18. The method as claimed in claim 12, wherein the first entity is an energy information function which can be logically independent entity or an independent Network Function (NF).

19. A method for obtaining a UE energy exposure information from at least one of a user equipment (UE) and a radio access network (RAN), the method comprising:
receiving, by a fourth entity, a UE energy event exposure subscription sixth request from a first entity using a exposure service API;
sending, by the fourth entity, a UE energy event exposure seventh request to the RAN using a core-RAN interface protocol message;
sending, by the fourth entity, a UE energy event exposure eighth request to the UE using an UE-core interface protocol message;
receiving, by the fourth entity, the UE energy event exposure sixth response from the RAN comprising plurality of RAN info attributes;
receiving, by the fourth entity, the UE energy event exposure seventh response from the UE comprising plurality of UE Energy info attributes;
sending, by the fourth entity the UE energy event exposure eighth response to the first entity; and
sending, by the first entity the UE energy event exposure ninth response to the first entity.

20. The method as claimed in claim 19, wherein the UE energy event exposure eighth response and the UE energy event exposure ninth response is sent as a single consolidated response.

21. (canceled)

22. The method as claimed in claim 19, wherein receiving UE energy event exposure sixth response is using one of a sixth response and at least one of a sixth notification, wherein receiving UE energy event exposure seventh response is using one of a seventh response and at least one of a seventh notification; wherein receiving UE energy event exposure eighth response is using one of a eighth response and at least one of a eighth notification; wherein receiving UE energy event exposure ninth response is using one of a ninth response and at least one of a ninth notification.

23. (canceled)

24. The method as claimed in claim 19, wherein the first entity is an energy information function which can be logically independent entity or an independent Network Function (NF) and wherein the fourth entity is an access and mobility management entity.

25. The method as claimed in claim 19, wherein the plurality of UE Energy Info attributes comprises at least one of battery status information, battery capacity, UE energy saving mode operation, and energy consumption reports; wherein the plurality of RAN info attributes includes radio condition information for the UE.

26. A method for obtaining UE energy exposure information from a user equipment (UE), the method comprising:
receiving by a fifth entity, a UE energy event exposure subscription ninth request from a first entity using a data path exposure service API;
sending by fifth entity, a UE energy event exposure tenth request to the UE using downlink data packet;
receiving by the fifth entity, at least one of UE event energy exposure tenth response and UE energy exposure tenth notification from the UE comprising plurality of UE Energy info attributes using uplink data packet; and
sending, by the fifth entity, at least one of the UE energy event exposure eleventh response and the UE energy exposure eleventh notification to the first entity using the data path exposure service API.

27. The method as claimed in claim 26, wherein the first entity is an energy information function which can be logically independent entity or an independent Network Function (NF) and wherein the fifth entity is a user plane entity and wherein the fifth entity handles a data path for energy information transfer for the requested UE.

28. (canceled)

29. The method as claimed in claim 26, wherein the downlink data packet includes an identifier of the UE energy event exposure request.

30. (canceled)

31. The method as claimed in claim 26, wherein the plurality of UE Energy Info attributes comprises at least one of battery status information, battery capacity, UE energy saving mode operation, and energy consumption reports.

32. (canceled)
